(19) United States
(12) Patent Application Publication
(10) Pub. No.: US 2004/0205154 A1
(43) Pub. Date: Oct. 14, 2004

(54) System for integrated mobile devices

(75) Inventors: Bryan L. Dalton, Endicott, NY (US); Michael A. Heaton, Owego, NY (US)

Correspondence Address: TAROLLI, SUNDHEIM, COVELL & TUMMINO LLP, 526 Superior Avenue - Suite 1111, CLEVELAND, OH, 44114, US

(73) Assignee: Lockheed Martin Corporation

(21) Appl. No.: 10/809,752

(22) Filed: Mar. 25, 2004

Related U.S. Application Data
(60) Provisional application No. 60/457,656, filed on Mar. 26, 2003.

(51) Int. Cl. G06F 15/16

(52) U.S. Cl. 709/217; 709/229

(57) ABSTRACT

A system includes a device management computer, a data concentrator computer for communicating with the device management computer, a gateway device for communicating with the data concentrator computer, and a plurality of mobile data acquisition devices. Each of the plurality of mobile data acquisition devices communicates with the gateway device. The gateway device performs pre-processing functions on data collected by the plurality of mobile data acquisition devices prior to transferring the data to the data concentrator computer.

### FIELD OF INVENTION

The present invention relates to a system for mobile devices, and more specifically, to a system for a plurality of integrated mobile devices.

### BACKGROUND OF THE INVENTION

A conventional data collection system may include a mobile unit utilizing applications software to collect and process data by a sequence of automated and/or manual operations. A typical automated process is the non-contact scanning of bar code data by means of a cyclically deflected laser beam or an image photosensor of the CCD type. Once a valid bar code reading has been obtained, a keypad may be manually operated to indicate an associated quantity. The user may then manually initiate a further operation, for example, the on-line transmission of the data to a remote host computer by a known means such as a radio frequency communications link.

### SUMMARY OF THE INVENTION

A system in accordance with the present invention includes a device management computer, a data concentrator computer for communicating with the device management computer, a gateway device for communicating with the data concentrator computer, and a plurality of mobile data acquisition devices. Each of the plurality of mobile data acquisition devices communicates with the gateway device. The gateway device performs pre-processing functions on data collected by the plurality of mobile data acquisition devices prior to transferring the data to the data concentrator computer.

Another system in accordance with the present invention transfers data. The system includes a device management computer, a data concentrator computer for communicating with the device management computer, a gateway device for communicating with the data concentrator computer, and a plurality of data acquisition devices. Each of the plurality of data acquisition devices communicates with the gateway device. The gateway device performs pre-processing functions on data collected by the plurality of data acquisition devices prior to transferring the data to the data concentrator computer. The data concentrator computer processes and stores data collected by the plurality of data acquisition devices.

A computer program product in accordance with the present invention controls a communication network. The computer program product includes a first instruction for collecting transaction log files of a plurality of mobile devices by a device management computer, a second instruction for receiving a software package from the device management computer by a data concentrator computer, a third instruction for performing a self test by a gateway device and sending results of the self test to a workstation, a fourth instruction for decrypting data from the gateway device by the workstation, and a fifth instruction for synchronizing time between the plurality of mobile devices, the gateway device, the device management computer, the data concentrator computer, and the workstation.

### BRIEF DESCRIPTION OF THE DRAWINGS

The foregoing and other features of the present invention will become apparent to one skilled in the art to which the present invention relates upon consideration of the following description of the invention with reference to the accompanying drawings, wherein:

FIG. 1 is a schematic representation of an example system in accordance with the present invention; and

FIGS. 2A, 2B, and 2C are a schematic representation of another example system in accordance with the present invention.

### DESCRIPTION OF THE PREFERRED EMBODIMENT

Mobile devices have tremendous data processing power and flexibility in sending business application data to a centralized computer. Conventionally, a mobile device may communicate with a mobile device charging/communications cradle or dock. The communication interface from the cradle to the computer may be an RS-232 serial (or some form of RS-232). Typically, there is a one to one relationship between the computer and the cradle. Although a computer can support more than one serial cradle, the logistics of maintaining 90 cradles, for example, by a single computer may necessarily require computationally intensive activity. In the conventional approach, the computer aggregates the data prior to sending a collection of data to a data concentrator computer.

Another conventional approach of concentrating 90 mobile devices by one computer is the aggregation of the mobile devices directly to a data concentrator computer. This approach has no mechanism to control or buffer data prior to transferring data to a centralized computer.

Still another conventional approach may include cradles that allow connectivity. However, the cradles necessarily communicate to the data concentrator concurrently. This approach is not efficient, particularly when a software download is required. For example, during a software update, each cradle requires great amounts of network bandwidth to transfer the entire software download to a mobile device. For 90 mobile devices, each mobile device would have a corresponding data concentrator for a software download session.

A system in accordance with the present invention may include an integrated mobile device services gateway for managing and controlling a plurality of mobile devices (i.e., 2 to N, where N is an integer greater than 1). Such a gateway may be positioned in the same room or geographic location as cradles for the mobile devices so that a user may dock a mobile device for charging and data communication. The gateway may provide local device management, data and network security, and multiplexing for communication efficiency. The gateway may further reduce redundant network traffic in the case of all mobile devices receiving the same data or software. The gateway may transfer the data to a more local storage area and distribute the common data locally.

The system, or architecture, may process a variety of electrical communication applications allowing the mobile device services gateway to interface between several networked and non-networked computers. As stated above, a conventional approach utilizes a cradle with no local storage. The conventional cradle is connected to a personal computer with a display. The computer acts as a gateway for concentrating data and distributing software locally. For small quantities of mobile devices disposed in one location, the mobile device would communicate directly with the data concentrator, without a local computer. With this approach, each mobile device has an individual communication session with the data concentrator. For example, if there were five mobile devices in a group to be updated, there would be five separate software download sessions.

A system in accordance with the present invention has a physical component that reduces the physical components of the conventional approach. A reduction of the quantity of parts may be reduced from 32 with the conventional approach to 16 with a system in accordance with the present invention. The lesser number of electrical devices may also reduce energy expended.

An example system in accordance with the present invention may include: a scaleable architecture from 2 to N mobile devices disposed in one physical location; system management functions integrated with business logic functions to reduce network traffic; management of one or more devices in groups or individually; and integration of installation and maintenance of physical components that require device specific data to be entered prior to operation.

The example system defines an architecture for two or more mobile devices communicating with one or more computers collecting business information from one or more locations (either same room or in different cities). This system is applicable where there exists one or more human users of the mobile devices collecting predetermined information at multiple locations. The system utilizes the transfer of data from a mobile device to a computer that collects and processes data and provides mobile device management.

A system in accordance with the present invention provides reduced quantities of physical part numbers by standardizing component functions, a reduction of electrical parts, a reduction in electrical power consumption, a scalable architecture from 2 or more mobile devices located in a single physical location, the integration of system management functions with business logic functions to reduce network traffic, the management of one or more devices in groups or individually, and the integration of installing and maintaining physical components requiring device specific data to be entered prior to operation.

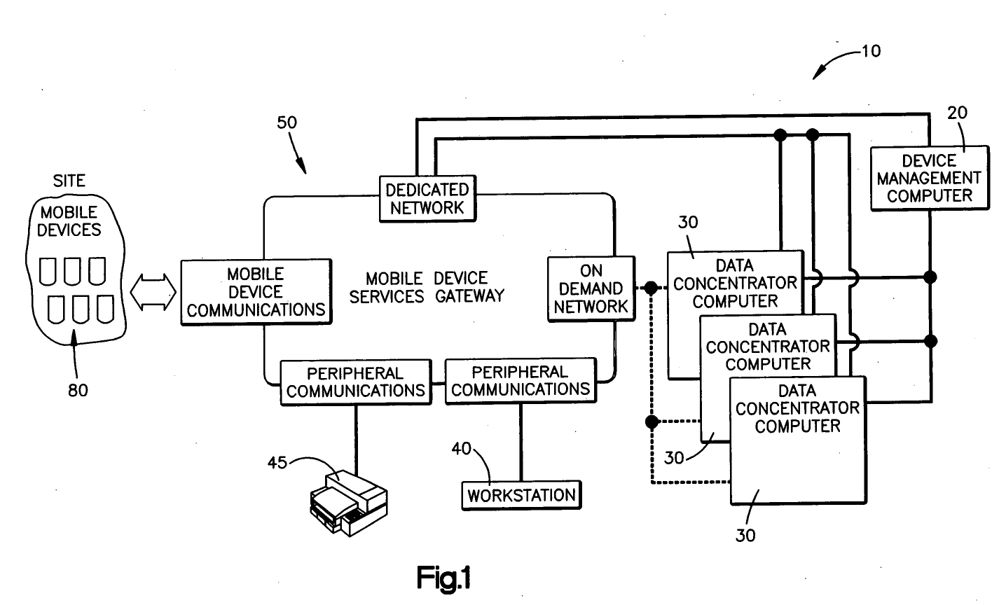

The example system 10 may have five main components. As shown in FIG. 1, the components may be a device management computer 20, one or more data concentrator computers 30, a workstation 40, a mobile device services gateway 50, and a plurality of mobile devices 80.

Depending on the amount of data to be collected, who collects the data, and where the data is collected may determine the specific quantity of physical system components (20, 30, 40, 50, 80). Each system component (20, 30, 40, 50, 80) may have the same system function independently of the quantity of components deployed. The example system 10 addresses the scalability of the system by keeping system functions identical, independent of quantity.

Geographically, the workstation 40, the mobile device services gateway 50, and the mobile devices 80 may be located in close proximity. A distance of the workstation 40, a printer 45, and the mobile devices 80 from the mobile device services gateway 50 may be dependent on the method for electrical communication. The device management computer 20 and the data concentrator computer(s) 30 may be located in a remote facility.

The complete example system 10 may include of multiple groups of workstations 40, mobile device services gateways 50, and mobile devices 80. Printers 45 may be optional peripherals to the example system 10.

The mobile devices 80 may be electronic devices that each have a computer processor, storage, display, keyboard and/or other automated input devices, batteries, and communication capability. The communication method for a mobile device 80 determines whether batch, near real time, or real time communications may occur. All communication methods may result in the mobile device 80 performing a communication session with a non-mobile device to transfer data to another component, typically a computer. The system 10 may use electrical, radio frequency, or optical communication methods. Some of these methods may be EIA RS-232, Universal Serial Bus; IEEE 802.3 Ethernet, IEEE802.5x Token Ring, IEEE 802.11x (where x is the one or more standards in this category), Wireless LAN, IEEE 802.3J Ethernet over Fiber (10BaseF), Fiber Distributed Data Interface, and/or Infrared Data Associated Interface.

The mobile device services gateway 50 may be a non-mobile device that transfers data between a mobile device 80 and a data concentrator computer 30. The mobile device services gateway 50 may provide the services for the mobile device 80 to communicate with other computers by transferring data via one or more communication methods. It is not necessary for the communication method for data received from a mobile device 80 to match the communication method for the data to be transferred to the data concentrator computer 30. The mobile device services gateway 50 converts the data to the appropriate electrical interface required to transfer the data.

The mobile devices services gateway 50 provides storage for reducing communications as permitted by the business operation requirements. For example, if there were 156 mobile devices 80 supported by a mobile devices services gateway 50, a software update to all 156 mobile devices would be reduced to one software application update transfer between a data concentrator computer 30 and the mobile device services gateway. Storage of the software application may occur on the mobile device services gateway 50 after the software package has been received from the data concentrator computer 30. Each mobile device 80 may obtain a copy of the most recent software application update from the mobile device services gateway 50.

Computer peripherals such as a printer 45, a CD-ROM, a diskette drive, and/or other computer may be connected to the mobile device services gateway 50. Since a mobile device 80 does not necessarily have computer peripherals, the mobile device, to print, may communicate with the mobile devices services gateway 50 to use the attached printer 45 or another network attached printer.

The data concentrator computer 30 supports the mobile devices 80 and groups of mobile devices deployed in the field. The data concentrator computer 30 may be dedicated or non-dedicated to a specific business software application. The data concentrator computer 30 supports the initial communications from the mobile devices 80 in the field. If business operations require collected data to be transferred to another computer or device, the data concentrator computer 30 may process, store, and communicate with another computer or device of the example system 10.

The device management computer 20 supports all devices used in the operation of the example system 10. The device management computer 20 may contain a centralized database configured by location, group within a location, and/or device. Device configuration information and software packages may be created or imported into the memory of the device management computer 20. Configuration information and software packages may be distributed to the data concentrator computer(s) 30 for re-distribution to groups of mobile devices 80 located remotely from the device management computer 20. Data concentrator computer(s) 30, workstation(s) 40, mobile device services gateway(s) 50, and mobile devices 80 may be managed by the device management computer 20.

Additional computer resources may be needed for collecting device management data sent to the data concentrator computer(s) 30. A history database of collected data for generating management reports may also be maintained on the device management computer 20.

The workstation 40 may be a computer for interfacing with the mobile device services gateway 50. The workstation 40 may locally maintain data where the mobile devices 80 are being used and may provide a method for mobile devices to transfer data to a removable media device (dependent on the configuration of the system 10). Business data collected by the mobile devices 80 may be transferred to the workstation 40 via the mobile device services gateway 50. Software on the workstation 40 may provide an interface for additional mobile device services such as exporting data to removable media (i.e., diskette, tape, CD-ROM, etc.), printing, and data processing (for reports and importing into other business applications.)

The mobile device(s) 80 may be configured, as needed, by the user to allow access to resources of the workstation 40 made available by the software operating for a specific function. Communications to the workstation 40 may be performed by one or more of the following electrical methods: electrical, radio frequency, or optical communications. As stated above, some of these methods may be EIA RS-232, Universal Serial Bus; IEEE 802.3 Ethernet, IEEE802.5x Token Ring, IEEE 802.11x (where x is the one or more standards in this category), Wireless LAN, IEEE 802.3J Ethernet over Fiber (10BaseF), Fiber Distributed Data Interface, and/or Infrared Data Associated Interface.

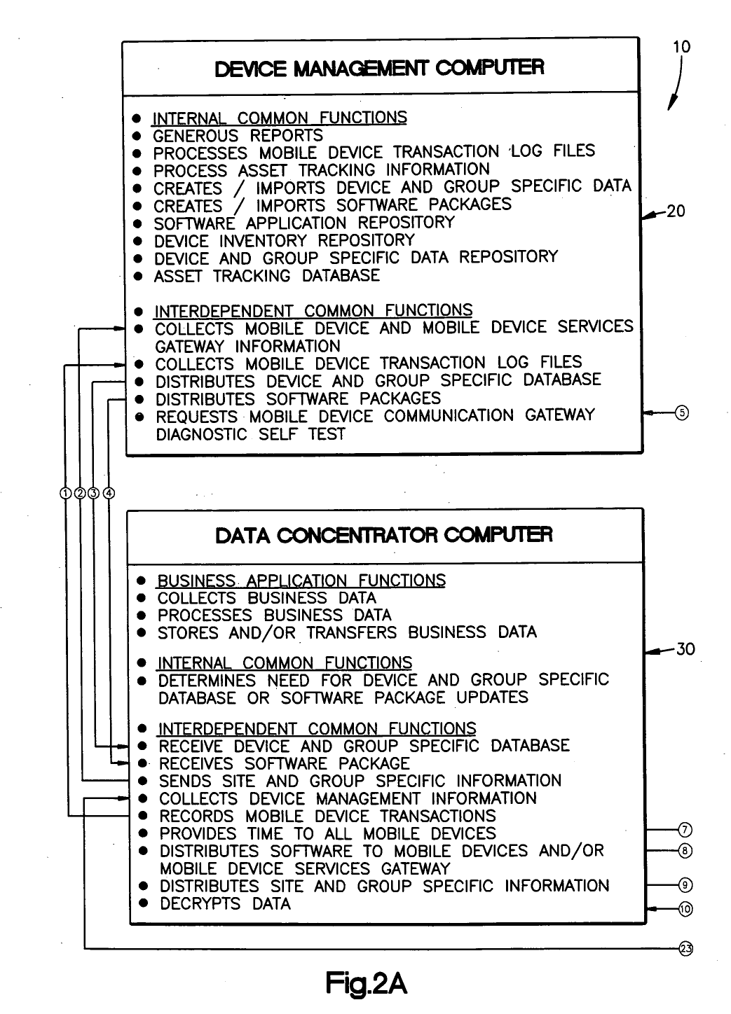

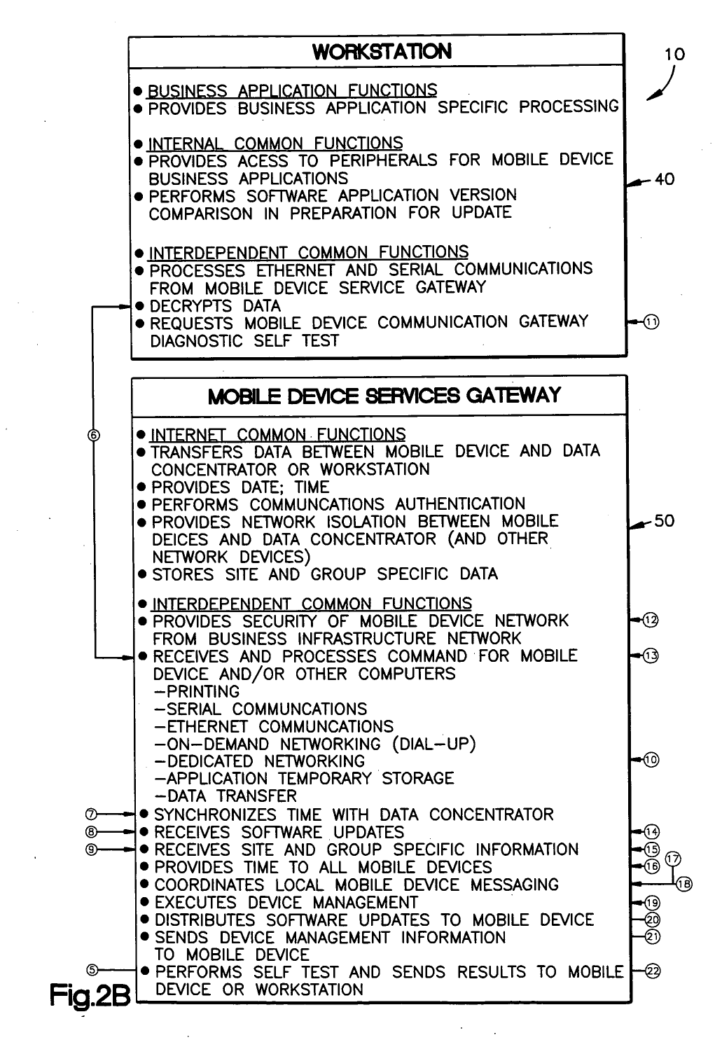

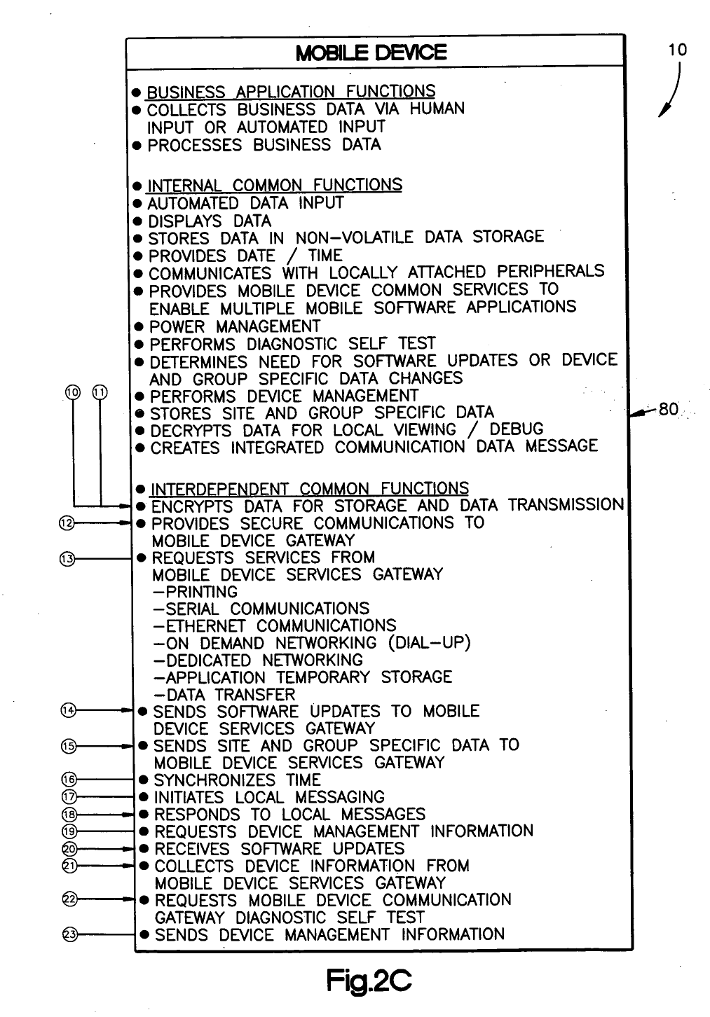

Relationships and functions internal to each of the physical components (20, 30, 40, 50, 80) of the example system 10 are described in FIG. 2. Within each physical component (20, 30, 40, 50, 80) the functions are categorized into: Business Application Functions, Internal Common Functions, and Interdependent Common Functions (as applicable).

Business Applications Functions are specific to the business process specific to the software. The example system 10 supports the interface to such software applications by providing common functions. Business Applications Functions use the common functions to create the desired behavior of the system 10.

Internal Common Functions are unique functions to a specific physical component (20, 30, 40, 50, or 80). For a mobile device 80, the Internal Common Functions may allow keypad input to an application or displaying data that is stored in the non-volatile storage area of the mobile device.

Interdependent Common Functions have a relationship that extends across the multiple physical components (20, 30, 40, 50, 80). Synchronizing time may be one function that extends across multiple physical components (20, 30, 40, 50, 80).

The following tables group the functions into physical components within the three previously defined categories. All functions defined for Business Applications are intended to be dependent on the business process in which the software is engineered to automate. Business application functions are described in Table 1.

TABLE 1
Business Application Functions

| | |
|---|---|
| Function | Purpose |

Mobile Device

| | |
|---|---|
| Collects business data via | Provides for data input |
| automated or human input | into the application |
| Processes business data | Provides for data |
| | processing |
| Display business data | Provides for viewing input |
| | or processed data |
| Stores business data | Provides for input or |
| | processed data storage |

Workstation

| | |
|---|---|
| Provides business | Keeps mobile device data |
| application specific | local by processing, |
| processing | storing and viewing data |

Data Concentrator

| | |
|---|---|
| Collects business data | Provides for aggregating |
| | business data across the |
| | entire system of all mobile |
| | devices |
| Processes business data | Provides for processing all |
| | collected business data |
| | across the system. Post |
| | processing may occur for |
| | changing the data format |
| | into a format used to |
| | interface with another |
| | computer in the system |
| Stores and/or transfers | Provides for storing, |
| business data | sharing, and/or |
| | transferring data |

Mobile device internal common functions are described in Table 2.

TABLE 2
Mobile Device Internal Common Functions

| Function | Purpose |
|---|---|
| Automated Data Input | Collects input data from 1D |
| | and/or 2D barcode scanners; |
| | and digitizers, magnetic |
| | stripe readers. Data |
| | collected from these |
| | devices would have a |
| | consistent behavior |
| | available to the business |
| | application. An example of |
| | consistent behavior for |
| | automated data input may be |
| | a long beep when an input |
| | is unsuccessful. |
| Displays Data | Provides common display |
| | formats for consistent |
| | graphical user interface. |
| | For example, an energy |
| | indicator may be presented |
| | to the user in the form of |
| | a battery graphic showing |
| | the amount of remaining |
| | energy. The energy graphic |
| | would be a common display |
| | format. |
| Stores Data in | Manages locations of data |
| Non-Volatile Memory | within the device to allow |
| | asynchronous application |
| | programs to store data in a |
| | consistent method. |
| Provides Date/Time | A real time clock that |
| | allows for time stamping of |
| | all transactions that |
| | require recording time |
| | events. All system events |
| | will time stamp with the |
| | real time clock. |
| Communicates with Locally | Supports electrical |
| Attached Peripherals | interfaces from the mobile |
| | device to (but not limited) |
| | the peripheral such as |
| | printers, magnetic stripe |
| | readers, and wireless wide |
| | area networks. |
| Provides Mobile Device | Allows for a common method |
| Common Services to Enable | to start, stop and run |
| Multiple Mobile Software | programs in parallel |
| Business Applications | without losing data. |
| | Should one mobile device |
| | program be started and |
| | perform operations that |
| | collect data and a second |
| | program be run before the |
| | first program is completed, |
| | this function will know |
| | that there is data to be |
| | transferred when the mobile |
| | device communicates. |
| | Mechanisms for switching |
| | between the applications to |
| | preserve the state prior to |
| | being changed to another |
| | application is a common |
| | function that is provided |
| | as an interface to business |
| | applications. |
| Power Management | Monitors power utilization |
| | throughout the device based |
| | on state of the application |
| | behavior and user behavior. |
| | The common method of |
| | utilizing the power |
| | management function will |
| | insure the total recovery |
| | of a software application |
| | that was switched to a |
| | second program. |
| Performs Diagnostic | Local user and remote |
| Self Test | system initiated test to |
| | validate the hardware and |
| | software are performing |
| | properly. Results of this |
| | test are logged locally on |
| | the device until there |
| | exists a retention limit to |
| | purge the data. |
| Determines Need for | A process to automatically |
| Software Updates or | determine whether the |
| Devices Specific | mobile device has the |
| Changes | latest software or device |
| | specific information |
| | resident. If not, requests |
| | the appropriate function to |
| | update software or devices |
| | specific information. |
| | Should a software update be |
| | interrupted while |
| | downloading, the device |
| | will recover at the most |
| | recent data end of |
| | file.marker. |
| Performs Device | Self test data, performance |
| Management | data, and device specific |
| | data are integrated into a |
| | format for communications. |
| | If no data is found at the |
| | time of initiation, then |
| | the software process will |
| | attempt to recreate the |
| | data prior to |
| | communication. This task |
| | may not be always performed |
| | prior to all data |
| | communications. This task |
| | may be programmed to be |
| | exempt from execution when |
| | business rules and system |
| | management rules dictate. |
| Stores Device Specific | Configuration data is |
| Data | stored on the device in the |
| | non-volatile memory area. |
| | This data is used for the |
| | Device Management task and |
| | integrating the information |
| | into business applications. |
| Decrypts Data for Local | Data stored on the |
| Viewing | non-volatile memory area is |
| | encrypted. Only certain |
| | users, as determined by the |
| | site, will have access to |
| | view data. |
| Creates Integrated | This function collects all |
| Communication Data Message | the data elements that |
| | comprises a communication |
| | session prior to physically |
| | connecting to the Mobile |
| | Device Services Gateway. |

Mobile device services gateway internal common functions are described in Table 3.

TABLE 3
Mobile Device Services
Gateway Internal Common Functions

| Function | Purpose |
|---|---|
| Transfers Data Between | Reads the predetermined |
| Mobile Device and Data | data format and determines |
| Concentrator; Mobile | what to do with the data, |
| Device and Workstation; or | where does the data get |
| Mobile Device and Data | routed and protects the two |
| Concentrator and | networks from unauthorized |
| Workstation. Data may be | intruders. |
| transferred on any | |
| direction depending on the | |
| business application | |
| Provides Date/Time | A real time clock that |
| | allows for time stamping of |
| | all transactions that |
| | require recording time |
| | events. All system events |
| | will time stamp with the |
| | real time clock. |
| Performs Network | User ID and Password are |
| Communications | user or programmatically |
| Authentication | entered prior to network |
| | access authentication. |
| | This function performs the |
| | determination of whether |
| | authorization is required |
| | and if required, insures |
| | the correct information is |
| | manually or automatically |
| | inserted at the correct |
| | time. |
| Provides Network Isolation | Internal firewall prevents |
| between Mobile Devices and | the data from being |
| Data Concentrator (and | transferred directly to the |
| other network devices) | opposite network from which |
| | the data was entered. |
| | Eliminates intruders from |
| | gaining access to larger |
| | intranet. |
| Stores Device and Group | One local data store for |
| Specific data | device and group specific |
| | data. |

Data concentrator computer internal common functions are described in Table 4.

TABLE 4
Data Concentrator
Computer Internal Common Functions

| Function | Purpose |
|---|---|
| Determines Need for Device | A process to automatically |
| Specific Distribution | determine whether the |
| Database or Software | mobile device has the |
| Package update | latest software or device |
| | specific information |
| | resident. If not, requests |
| | the appropriate function to |
| | update software or devices |
| | specific information. |
| | Should a software update be |
| | interrupted while |
| | downloading, the device |
| | will recover at the most |
| | recent data end of file |
| | marker. |

Device management computer internal common functions are described in Table 5.

TABLE 5
Device Management
Computer Internal Common Functions

| Function | Purpose |
|---|---|
| Generates Reports | Provides the user with |
| | information about the |
| | system. Reports may be |
| | (but not limited to) 1) |
| | What Devices did not |
| | communicate in the last |
| | day, two days, etc. 2) |
| | How many devices are in |
| | this geographic area? 3) |
| | What devices do not have |
| | the latest software |
| | upgrade? 4) How many |
| | devices transmitted data |
| | to the data concentrator |
| | in the last 24 hours. |
| Processes Mobile Device | Mobile device |
| Transaction Log Files | communication sessions are |
| | automatically recorded on |
| | the data concentrator. |
| | These transactions are |
| | stored into historical |
| | logs. When there is more |
| | than one data |
| | concentrator, the Device |
| | Manager will collect all |
| | Mobile Device transaction |
| | logs and reassemble into |
| | chronology of events and |
| | stored as an integrated |
| | file. |
| Processes Asset | This function tracks the |
| Tracking | life cycle of an asset. |
| Information | Using the systems device |
| | management functions, data |
| | is generated and collected |
| | during normal network |
| | conversation to tell where |
| | a device has been used or |
| | stored. |
| Creates/Imports | Device and Group specific |
| Device and | data sent to the deployed |
| Group Specific | devices are entered into |
| Data | the system through the |
| | Device Manager. The |
| | device manager will accept |
| | manually created data or a |
| | file that contains the |
| | correct import format. |
| Creates/Imports | Software Packages sent to |
| Software | the deployed devices are |
| Packages | entered into the system |
| | through the Device |
| | Manager. The device |
| | manager will accept |
| | manually created data or a |
| | file that contains the |
| | correct import format. |
| | The device manager will |
| | automatically propagate |
| | the latest software |
| | version to the Data |
| | Concentrator for |
| | re-distribution to the |
| | individual devices. |
| Software Application | Storage area for all |
| Repository | software packages in the |
| | system. System physical |
| | components supported for |
| | this function are: Mobile |
| | Devices, Mobile Device |
| | Services Gateway, |
| | Workstation, and Data |
| | Concentrator Computer |
| Device Inventory | Storage area for the |
| Repository | relationship configuration |
| | of Mobile Devices and |
| | Mobile Device Services |
| | Gateway by deployed |
| | groups. |
| Device Specific | Configuration information |
| Data | for each mobile device. |
| Repository | This data is used for |
| | reports and system |
| | distribution to other |
| | devices such as the Data |
| | Concentrator, Mobile |
| | Device Services Gateway, |
| | and Mobile Device. |
| Asset Tracking | Storage of the data |
| Database | processed during the |
| | Processes Asset Tracking |
| | Information |

Workstation internal common functions are described in Table 6.

TABLE 6
Workstation Internal Common Functions

| Function | Purpose |
|---|---|
| Provides Access to | Share workstation |
| Peripherals for Mobile | peripherals such as |
| Device Business | Diskette drive, CD-ROM and |
| Applications | Printers with Mobile |
| | Devices. Allows a mobile |
| | device to directly access a |
| | shared resource on a |
| | Workstation that is |
| | connected to the mobile |
| | device services gateway. |
| Performs Software | Device and Group specific |
| Application Version | data sent to the deployed |
| Comparison in Preparation | devices are entered into |
| for Update | the system through the |
| | Device Manager. The device |
| | manager will accept |
| | manually created data or a |
| | file that contains the |
| | correct import format. |

Table 7 shows the relationships between the physical components (20, 30, 40, 50, 80). These relationships are the interfaces that define the behavior of the example system 10. In Table 7, the relationships are described by numeric value associated with each interconnection shown in FIG. 2. Table 7 specifically describes these interconnections.

TABLE 7
Interdependent Common Functions

| Id# | Component #1 | Component #2 | Purpose |
|---|---|---|---|
| 1 | Device | Data | Performs the data |
| | Management | Concentrator | transfer of |
| | Computer | Computer | Mobile Device |
| | | | Transactions that |
| | | | are generated on |
| | | | the Data |
| | | | Concentrator. |
| | | | Should one or |
| | | | more Mobile |
| | | | Devices desire to |
| | | | communicate |
| | | | concurrently when |
| | | | associated with |
| | | | the same group, |
| | | | the system shall |
| | | | prevent multiples |
| | | | from |
| | | | communicating. |
| 2 | Device | Data | Performs the data |
| | Management | Concentrator | transfer of: |
| | Computer | Computer | Device and Group |
| | | | specific data to |
| | | | the Data |
| | | | Concentrator. |
| | | | Should one or |
| | | | more Mobile |
| | | | Devices desire to |
| | | | communicate |
| | | | concurrently when |
| | | | associated with |
| | | | the same group, |
| | | | the system shall |
| | | | prevent multiples |
| | | | from |
| | | | communicating. |
| 3 | Device | Data | Performs the |
| | Management | Concentrator | distribution |
| | Computer | Computer | between two |
| | | | computers of the |
| | | | Device and Group |
| | | | Specific data. |
| | | | The system only |
| | | | allows this data |
| | | | to be transferred |
| | | | once to a group. |
| 4 | Device | Data | Performs the |
| | Management | Concentrator | distribution of |
| | Computer | Computer | software packages |
| | | | to the Data |
| | | | Concentrators. |
| 5 | Device | Mobile | Initiates a field |
| | Management | Device | request to engage |
| | Computer | Services | in remote |
| | | Gateway | diagnostics of a |
| | | | Mobile Device |
| | | | Services Gateway |
| | | | from a Device |
| | | | Management |
| | | | Computer. The |
| | | | data generated |
| | | | from the remote |
| | | | diagnostics may |
| | | | be transferred to |
| | | | the Device |
| | | | Management |
| | | | Computer. |
| 6 | Mobile Device | Workstation | Request for |
| | Services | | common services |
| | Gateway | | of the Mobile |
| | | | Device Gateway. |
| | | | The workstation |
| | | | may request |
| | | | stored |
| | | | information to be |
| | | | transferred over |
| | | | to the |
| | | | workstation for |
| | | | data storage and |
| | | | specific business |
| | | | data processing |
| | | | and reports. |
| 7 | Data | Mobile | Performs time |
| | Concentrator | Device | synchronization |
| | Computer | Services | between the two |
| | | Gateway | devices. This |
| | | | time |
| | | | synchronization |
| | | | may not occur for |
| | | | each and every |
| | | | communication |
| | | | conversation. At |
| | | | a minimum a time |
| | | | synchronization |
| | | | will occur once a |
| | | | day unless forced |
| | | | by a user. |
| 8 | Data | Mobile | Performs the |
| | Concentrator | Device | distribution of |
| | Computer | Services | software packages |
| | | Gateway | to the Mobile |
| | | | Device Services |
| | | | Gateway. |
| 9 | Data | Mobile | Performs the |
| | Concentrator | Device | distribution |
| | Computer | Services | between two |
| | | Gateway | computers of the |
| | | | Device and Group |
| | | | Specific data. |
| | | | The system only |
| | | | allows this data |
| | | | to be transferred |
| | | | once to a group. |
| 10 | Mobile Device | Data | Business data, |
| | | Concentrator | Device and Group |
| | | Computer | Specific Data are |
| | | | encrypted and |
| | | | decrypted when |
| | | | transferring data |
| | | | over the network. |
| 11 | Mobile Device | Workstation | Business data, |
| | | | Device and Group |
| | | | Specific Data are |
| | | | encrypted and |
| | | | decrypted when |
| | | | transferring data |
| | | | over the network. |
| 12 | Mobile Device | Mobile | Network security |
| | | Device | is enabled to |
| | | Services | insure that |
| | | Gateway | Mobile Devices |
| | | | are not able to |
| | | | directly access a |
| | | | businesses |
| | | | intranet. |
| 13 | Mobile Device | Mobile | Request for |
| | | Device | common services |
| | | Services | of the Mobile |
| | | Gateway | Device Gateway. |
| | | | The Mobile Device |
| | | | may request |
| | | | stored |
| | | | information to be |
| | | | exported to a |
| | | | Diskette Drive |
| | | | located on the |
| | | | workstation. Or |
| | | | the Mobile Device |
| | | | may transfer data |
| | | | to the Mobile |
| | | | Device Services |
| | | | Gateway for the |
| | | | workstation to |
| | | | retrieve. |
| 14 | Mobile Device | Mobile | The Mobile Device |
| | | Device | Services Gateway |
| | | Services | performs the |
| | | Gateway | distribution of |
| | | | software packages |
| | | | to the Mobile |
| | | | Device. |
| 15 | Mobile Device | Mobile | The Mobile Device |
| | | Device | Services Gateway |
| | | Services | performs the |
| | | Gateway | distribution of |
| | | | Device and Group |
| | | | Specific data to |
| | | | the Mobile |
| | | | Device. |
| 16 | Mobile Device | Mobile | Performs time |
| | | Device | synchronization |
| | | Services | between the two |
| | | Gateway | devices. This |
| | | | time |
| | | | synchronization |
| | | | may not occur for |
| | | | each and every |
| | | | communication |
| | | | conversation. At |
| | | | a minimum a time |
| | | | synchronization |
| | | | will occur once a |
| | | | day unless forced |
| | | | by a user. |
| 17 | Mobile Device | Mobile | A local message |
| | | Device | request is sent |
| | | Services | to the Mobile |
| | | Gateway | Device Services |
| | | | Gateway to |
| | | | initiate a remote |
| | | | process. This |
| | | | remote process |
| | | | may collect data |
| | | | from other Mobile |
| | | | Devices when |
| | | | requested by one |
| | | | Mobile Device. |
| 18 | Mobile Device | Mobile | A remote message |
| | | Device | from the Mobile |
| | | Services | Device Services |
| | | Gateway | Gateway is |
| | | | received. The |
| | | | message requires |
| | | | the current |
| | | | software versions |
| | | | installed on the |
| | | | device. The |
| | | | Mobile Device |
| | | | responds by |
| | | | sending the list |
| | | | of software |
| | | | versions |
| | | | currently |
| | | | installed. The |
| | | | remote message |
| | | | response is |
| | | | complete and the |
| | | | Mobile Device |
| | | | waits for the |
| | | | next message. |
| 19 | Mobile Device | Mobile | A request of the |
| | | Device | Mobile Device |
| | | Services | Services Gateway |
| | | Gateway | for Device |
| | | | Management |
| | | | Information. |
| 20 | Mobile Device | Mobile | The Mobile Device |
| | | Device | receives a |
| | | Services | software update |
| | | Gateway | through the |
| | | | software |
| | | | distribution |
| | | | process. |
| 21 | Mobile Device | Mobile | Device Management |
| | | Device | Information about |
| | | Services | the Mobile Device |
| | | Gateway | Services Gateway |
| | | | is sent. This |
| | | | information is |
| | | | collected prior |
| | | | to a |
| | | | communication |
| | | | session with the |
| | | | Data |
| | | | Concentrator. |
| 22 | Mobile Device | Mobile | Initiates a field |
| | | Device | request to engage |
| | | Services | in remote |
| | | Gateway | diagnostics of a |
| | | | Mobile Device |
| | | | Services Gateway |
| | | | from a Mobile |
| | | | Device. The data |
| | | | generated from |
| | | | the remote |
| | | | diagnostics may |
| | | | be transferred to |
| | | | the Mobile |
| | | | Device. |
| 23 | Mobile Device | Data | Performs the data |
| | | Concentrator | transfer of: |
| | | | Device and Group |
| | | | specific data to |
| | | | the Data |
| | | | Concentrator. |
| | | | Should one or |
| | | | more Mobile |
| | | | Devices desire to |
| | | | communicate |
| | | | concurrently when |
| | | | associated with |
| | | | the same group, |
| | | | the system shall |
| | | | prevent multiples |
| | | | from |
| | | | communicating. |

Terminology used above is supplementally defined in Table 8.

TABLE 8
Definitions

| Term | Definition |
|---|---|
| Mobile Device | A data computing device |
| | that is portable and used |
| | by a human. The data |
| | computing device may have |
| | automated data input |
| | methods such as bar code |
| | readers, digitizers, voice |
| | recognition, magnetic |
| | stripe readers and optical |
| | character recognition |
| Mobile Device | The process of |
| Management | electronically managing the |
| | mobile device for the |
| | intent of collecting |
| | information or improving |
| | the common system |
| | functions. This may |
| | include but not be limited |
| | to software application |
| | updates, mobile device |
| | performance data, executing |
| | remote procedures (such as |
| | diagnostic or resource |
| | tools) |
| Device and | Information relating to a |
| Group Specific | geographic location of the |
| Data | system or system components |
| | (i.e., Mobile Device, or |
| | Mobile Services Gateway). |
| | The information may |
| | consists (but not be |
| | limited to) of site name, |
| | address, telephone number, |
| | networking properties, |
| | associated information |
| | technology devices, |
| | business usage rules. |

An example system 10 a device management computer 20, a data concentrator computer 30 for communicating with the device management computer, a gateway device 50 for communicating with the data concentrator computer, and a plurality of mobile data acquisition devices 80. Each of the plurality of mobile data acquisition devices 80 communicates with the gateway device 50. The gateway device 50 performs pre-processing functions on data collected by the plurality of mobile data acquisition devices 80 prior to transferring the data to the data concentrator computer 30.

Another example system 10 transfers data. The system 10 includes a device management computer 20, a data concentrator computer 30 for communicating with the device management computer, a gateway device 50 for communicating with the data concentrator computer, and a plurality of data acquisition devices 80. Each of the plurality of data acquisition devices 80 communicates with the gateway device 50. The gateway device 50 performs pre-processing functions on data collected by the plurality of data acquisition devices 80 prior to transferring the data to the data concentrator computer 30. The data concentrator computer 30 processes and stores data collected by the plurality of data acquisition devices 80.

An example computer program product (FIG. 2) controls a communication network 10. The computer program product includes a first instruction (step 1) for collecting transaction log files of a plurality of mobile devices 80 by a device management computer 20, a second instruction (step 4) for receiving a software package from the device management computer 20 by a data concentrator computer 30, a third instruction (step 5) for performing a self test by a gateway device 50 and sending results of the self test to a workstation 40, a fourth instruction (step 6) for decrypting data from the gateway device 50 by the workstation 40, and a fifth instruction (step 7) for synchronizing time between the plurality of mobile devices 80, the gateway device 50, the device management computer 20, the data concentrator computer 30, and the workstation 40.

In order to provide a context for the various aspects of the present invention, the following discussion is intended to provide a brief, general description of a suitable computing environment in which the various aspects of the present invention may be implemented. While the invention has been described above in the general context of computer-executable instructions of a computer program that runs on a computer, those skilled in the art will recognize that the invention also may be implemented in combination with other program modules.

Generally, program modules include routines, programs, components, data structures, etc. that perform particular tasks or implement particular abstract data types. Moreover, those skilled in the art will appreciate that the inventive methods may be practiced with other computer system configurations, including single-processor or multiprocessor computer systems, minicomputers, mainframe computers, as well as personal computers, hand-held computing devices, microprocessor-based or programmable consumer electronics, and the like. The illustrated aspects of the invention may also be practiced in distributed computing environments where tasks are performed by remote processing devices that are linked through a communications argument model. However, some, if not all aspects of the invention can be practiced on stand-alone computers. In a distributed computing environment, program modules may be located in both local and remote memory storage devices.

An exemplary system for implementing the various aspects of the invention includes a conventional server computer, including a processing unit, a system memory, and a system bus that couples various system components including the system memory to the processing unit. The processing unit may be any of various commercially available processors. Dual microprocessors and other multi-processor architectures also can be used as the processing unit. The system bus may be any of several types of bus structure including a memory bus or memory controller, a peripheral bus, and a local bus using any of a variety of conventional bus architectures. The system memory includes read only memory (ROM) and random access memory (RAM). A basic input/output system (BIOS), containing the basic routines that help to transfer information between elements within the server computer, such as during start-up, is stored in ROM.

The server computer further includes a hard disk drive, a magnetic disk drive, e.g., to read from or write to a removable disk, and an optical disk drive, e.g., for reading a CD-ROM disk or to read from or write to other optical media. The hard disk drive, magnetic disk drive, and optical disk drive are connected to the system bus by a hard disk drive interface, a magnetic disk drive interface, and an optical drive interface, respectively. The drives and their associated computer-readable media provide nonvolatile storage of data, data structures, computer-executable instructions, etc., for the server computer. Although the description of computer-readable media above refers to a hard disk, a removable magnetic disk and a CD, it should be appreciated by those skilled in the art that other types of media which are readable by a computer, such as magnetic cassettes, flash memory cards, digital video disks, Bernoulli cartridges, and the like, may also be used in the exemplary operating environment, and further that any such media may contain computer-executable instructions for performing the methods of the present invention.

A number of program modules may be stored in the drives and RAM, including an operating system, one or more application programs, other program modules, and program data. A user may enter commands and information into the server computer through a keyboard and a pointing device, such as a mouse. Other input devices (not shown) may include a microphone, a joystick, a game pad, a satellite dish, a scanner, or the like. These and other input devices are often connected to the processing unit through a serial port interface that is coupled to the system bus, but may be connected by other interfaces, such as a parallel port, a game port or a universal serial bus (USB). A monitor or other type of display device is also connected to the system bus via an interface, such as a video adapter. In addition to the monitor, computers typically include other peripheral output devices (not shown), such as speaker and printers.

The server computer may operate in a networked environment using logical connections to one or more remote computers, such as a remote client computer. The remote computer may be a workstation, a server computer, a router, a peer device or other common network node, and typically includes many or all of the elements described relative to the server computer. The logical connections include a local area network (LAN) and a wide area network (WAN). Such networking environments are commonplace in offices, enterprise-wide computer networks, intranets and the internet.

When used in a LAN networking environment, the server computer is connected to the local network through a network interface or adapter. When used in a WAN networking environment, the server computer typically includes a modem, or is connected to a communications server on the LAN, or has other means for establishing communications over the wide area network, such as the internet. The modem, which may be internal or external, is connected to the system bus via the serial port interface. In a networked environment, program modules depicted relative to the server computer, or portions thereof, may be stored in the remote memory storage device. It will be appreciated that the network connections shown are exemplary and other means of establishing a communications link between the computers may be used.

In accordance with the practices of persons skilled in the art of computer programming, the present invention has been described with reference to acts and symbolic representations of operations that are performed by a computer, such as the server computer, unless otherwise indicated. Such acts and operations are sometimes referred to as being computer-executed. It will be appreciated that the acts and symbolically represented operations include the manipulation by the processing unit of electrical signals representing data bits which causes a resulting transformation or reduction of the electrical signal representation, and the maintenance of data bits at memory locations in the memory system (including the system memory, hard drive, floppy disks, and CD-ROM) to thereby reconfigure or otherwise alter the computer system's operation, as well as other processing of signals. The memory locations where such data bits are maintained are physical locations that have particular electrical, magnetic, or optical properties corresponding to the data bits.

It will be understood that the above description of the present invention is susceptible to various modifications, changes and adaptations, and the same are intended to be comprehended within the meaning and range of equivalents of the appended claims. The presently disclosed embodiments are considered in all respects to be illustrative, and not restrictive. The scope of the invention is indicated by the appended claims, rather than the foregoing description, and all changes that come within the meaning and range of equivalence thereof are intended to be embraced therein.

Having described the invention, we claim:

1. A communication system comprising:
a device management computer;
a data concentrator computer for communicating with said device management computer;
a gateway device for communicating with said data concentrator computer; and
a plurality of mobile data acquisition devices, each of said plurality of mobile data acquisition devices communicating with said gateway device,
said gateway device performing pre-processing functions on data collected by said plurality of mobile data acquisition devices prior to transferring the data to said data concentrator computer.

2. The system as set forth in claim 1 further including a workstation for communicating with said gateway device.

3. The system as set forth in claim 2 wherein said workstation provides access to resources of said workstation by said plurality of mobile data acquisition devices through said gateway device.

4. The system as set forth in claim 1 wherein each of said plurality of mobile data acquisition devices includes a processor, a memory, a display, a keyboard, and a battery.

5. The system as set forth in claim 1 wherein each of said plurality of mobile data acquisition devices performs a batch download of said data to said gateway device.

6. The system as set forth in claim 1 wherein each of said plurality of mobile data acquisition devices performs a real time download of said data to said gateway device.

7. The system as set forth in claim 1 wherein said gateway device converts said data to an appropriate interface for transferring said data to said data concentrator computer.

8. The system as set forth in claim 1 wherein said gateway device provides communication to a printer.

9. The system as set forth in claim 1 wherein said gateway provides communication to a diskette drive.

10. The system as set forth in claim 1 wherein said data concentrator computer is dedicated to a single software application.

11. A system for transferring data, said system comprising:
a device management computer;
a data concentrator computer for communicating with said device management computer;
a gateway device for communicating with said data concentrator computer; and
a plurality of data acquisition devices, each of said plurality of data acquisition devices communicating with said gateway device,
said gateway device performing pre-processing functions on data collected by said plurality of data acquisition devices prior to transferring the data to said data concentrator computer,
said data concentrator computer processing and storing data collected by said plurality of data acquisition devices.

12. The system as set forth in claim 11 wherein said data concentrator computer supports initial communication from said plurality of data acquisition devices.

13. The system as set forth in claim 11 said device management computer includes an information database containing configuration data of each of said plurality of data acquisition devices.

14. The system as set forth in claim 11 wherein said device management computer distributes software packages to said data acquisition devices through said data concentrator computer.

15. The system as set forth in claim 11 said device management computer maintains a history database for generating management reports.

16. A computer program product for controlling a communication network, said computer program product comprising:
a first instruction for collecting transaction log files of a plurality of mobile devices by a device management computer;
a second instruction for receiving a software package from the device management computer by a data concentrator computer;
a third instruction for performing a self test by a gateway device and sending results of the self test to a workstation;
a fourth instruction for decrypting data from the gateway device by the workstation; and
a fifth instruction for synchronizing time between the plurality of mobile devices, the gateway device, the device management computer, the data concentrator computer, and the workstation.

17. The computer program product as set forth in claim 16 further including a sixth instruction for receiving a software update from the data concentrator computer by the gateway device.

18. The computer program product as set forth in claim 17 further including a seventh instruction for processing commands of the plurality of mobile devices by the gateway device.

19. The computer program product as set forth in claim 18 further including an eighth instruction for initiating local messaging by the plurality of mobile devices.

20. The computer program product as set forth in claim 19 further including a ninth instruction for providing a data and a time by the gateway device.
